(19) United States
(12) Patent Application Publication
(10) Pub. No.: US 2024/0351293 A1
(43) Pub. Date: Oct. 24, 2024

(54) CONSTRUCTION MATS AND METHODS OF MANUFACTURE

(71) Applicant: Richard Sofia, Troy, OH (US)

(72) Inventor: Richard Sofia, Troy, OH (US)

(21) Appl. No.: 18/302,476

(22) Filed: Apr. 18, 2023

(51) Int. Cl. B29C 65/64; B29C 65/00; B29C 65/56

(52) U.S. Cl. CPC B29C 65/64; B29C 65/004; B29C 65/562; B29L 2031/7324

(57) ABSTRACT

A construction mat section may be formed by combining together a molded bottom mat component and a molded top mat component. In some instances, one or both of the molded bottom mat component and the molded top mat component may include ribs that are molded into the molded bottom mat component and/or the molded top mat component. Reinforcing members may be secured to at least some of the ribs in order to improve weight bearing capacity of the construction mat section by making the construction mat section stiffer. Several construction mat sections may be joined together to provide a construction mat assembly.

### TECHNICAL FIELD

The present disclosure pertains to systems and methods for molding polymeric structures. More particularly, the present disclosure relates to polymeric structures such as construction mats and methods for their manufacture.

### BACKGROUND

A wide variety of polymeric structures such as construction mats, as well as methods for their manufacture, are known. Of the known systems and methods, each has certain advantages and disadvantages. There is an ongoing need to provide alternative structures such as construction mats.

### SUMMARY

This disclosure provides systems and methods for molding polymeric structures such as construction mats. An example may be found in a construction mat section. The construction mat section includes a molded bottom mat component, a molded top mat component configured to be securable to the molded bottom mat component, a plurality of ribs formed in at least one of the molded top mat component and the molded bottom mat component, and one or more reinforcing members secured relative to at least some of the plurality of ribs.

Alternatively or additionally, the plurality of ribs may be arranged in pairs of ribs, with each pair of ribs including a first rib and a second rib that is spaced less than one inch apart from the first rib, and at least some of the pairs of ribs include one of the one or more reinforcing members disposed between the first rib and the second rib.

Alternatively or additionally, the reinforcing member may be secured between the first rib and the second rib using a thermal process in which the first rib and the second rib are heated to at least 160° F.

Alternatively or additionally, for at least some of the pairs of ribs, the first rib and the second rib may be spaced less than one half inch apart.

Alternatively or additionally, for at least some of the pairs of ribs, the first rib and the second rib may be spaced less than one quarter inch apart.

Alternatively or additionally, at least some of the one or more reinforcing members may have a U-shaped profile and may fit over one or more of the ribs.

Alternatively or additionally, the molded bottom mat component and the molded top mat component may have a combined thickness of less than three inches.

Alternatively or additionally, the one or more reinforcing members may include metal.

Alternatively or additionally, the one or more reinforcing members may include a fibrous material, a polymeric material or combinations thereof.

Alternatively or additionally, at least some of the one or more reinforcing members may extend a length of at least some of the pairs of ribs spaced less than one inch apart.

Alternatively or additionally, a construction mat assembly may include four construction mat sections joined together.

Another example may be found in a construction mat section. The construction mat section may include a molded top mat component including a first mating surface and a molded bottom mat component including a second mating surface in opposition with the first mating surface. A plurality of tubular reinforcing members extend between the first mating surface and the second mating surface.

Alternatively or additionally, the first mating surface may include protuberances configured to accommodate each of the plurality of tubular reinforcing members.

Alternatively or additionally, the second mating surface may include protuberances configured to accommodate each of the plurality of tubular reinforcing members.

Alternatively or additionally, at least some of the plurality of tubular reinforcing members may include cylindrical reinforcing members.

Alternatively or additionally, at least some of the tubular reinforcing members may include steel reinforcing members.

Alternatively or additionally, the tubular reinforcing members may be secured between the molded top mat component and the molded bottom mat component at a temperature of at least 160° F.

Alternatively or additionally, the molded bottom mat component and the molded top mat component may have a combined thickness of less than three inches.

Alternatively or additionally, at least one of the molded top mat component and the molded bottom mat component may further include a plurality of ribs in combination with the plurality of tubular reinforcing members.

Another example may be found in a method of forming a construction mat section. The method includes providing a molded bottom mat component including a plurality of ribs, positioning a reinforcement member proximate at least some of the plurality of ribs, heating the molded bottom mat component to a temperature of at least 160° F., allowing the molded bottom mat component to cool in order to lock the reinforcement member in position relative to the plurality of ribs, and securing a molded top mat component to the molded bottom mat component.

Alternatively or additionally, securing the molded top mat component to the molded bottom mat component may include using a cold molding process.

Alternatively or additionally, securing the molded top mat component to the molded bottom mat component may include using fasteners.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a schematic block diagram showing a pair of polymeric components being pressed together in a press;

FIG. 2 is a schematic top view of a polymeric component such as one of the pair of polymeric components of FIG. 1;

FIG. 3A is a schematic cross-sectional view of the polymeric components of FIG. 2, taken along line 3-3 of FIG. 2;

FIG. 3B is another schematic cross-sectional view of the polymeric components of FIG. 2, corresponding to line 3-3 of FIG. 2;

FIG. 4 is a schematic cross-sectional view of a polymeric structure formed from the pair of polymeric components shown in FIG. 1;

FIG. 5 is a flow diagram showing an illustrative method of forming a polymeric structure from a first polymeric component and a second polymeric component;

FIG. 6 is a flow diagram showing an illustrative method of forming a polymeric structure from a first polymeric component and a second polymeric component;

FIG. 7 is a flow diagram showing an illustrative method of forming a construction mat;

FIG. 8 is a flow diagram showing an illustrative method of forming a construction mat quadrant;

FIG. 9 is a flow diagram showing an illustrative method of forming a construction mat;

FIG. 10 is a perspective view showing an upper surface of a top construction mat component;

FIG. 11 is a perspective view showing a lower surface of the top construction mat component shown in FIG. 10;

FIG. 12 is a perspective view showing a lower surface of a bottom construction mat component;

FIG. 13 is a perspective view showing an upper surface of the bottom construction mat component shown in FIG. 12;

FIG. 14 is a perspective view showing the top construction mat component shown in FIGS. 10 and 11 being aligned with and joined with the bottom construction mat component shown in FIGS. 12 and 13;

FIG. 15 is a schematic perspective view of a construction mat component that may be considered as representing either of a top construction mat component or a bottom construction mat component;

FIG. 16A is a first schematic cross-sectional view taken along line 16-16 of FIG. 15;

FIG. 16B is a second schematic cross-sectional view taken along line 16-16 of FIG. 15;

FIGS. 17A through 17D are schematic views providing illustrative supporting rib patterns;

FIGS. 18A through 18C are schematic views providing examples of illustrative reinforcing members;

FIG. 18D is a schematic view providing an example of an illustrative rib structure;

FIGS. 19A and 19B are schematic views providing illustrative reinforcing members;

FIGS. 20A and 20B are schematic views providing illustrative reinforcing members;

FIG. 21 is a flow diagram showing an illustrative method; and

FIG. 22 is a schematic top view of a construction mat formed by assembling four construction mat sections or quadrants.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

A number of polymeric structures may be formed from two (or more) distinct polymeric components that may be individually formed and then subsequently joined together to form the polymeric structure. In some cases, the polymeric structure may be too large or complex to mold as a single component. In some cases, individual polymeric components may be molded, for example. In some cases, individual polymeric components may be 3D printed. In some cases, the polymeric structure may be formed via a cold molding system in which already formed parts are remade into a new structure, such as the polymeric structure.

In some cases, a cold molding system can reduce or even eliminate the bolting, welding or gluing that may otherwise be used in joining two or more parts or materials together. In some cases, the polymeric structures described herein may be joined together using bolts or other fasteners such as screws or rivets. In some cases, the polymeric structures described herein may be joined together using an adhesive, for example.

A cold molding system joins together two (or more) polymeric components (e.g., components that are previously made and that are at or close to ambient temperature. A charge may be applied between the two (or more) polymeric components. In some cases, one or more thin lines may be ground or otherwise formed in the facing surfaces of the two (or more) polymeric components to be joined together. The location of the one or more thin lines may correspond to where the charge will be placed. In some cases, there may not be any thin lines ground or otherwise formed, and the charge can be placed in any desired location regardless of whether there are any grooves or thin lines.

In some cases, the charge may be heated, and thus is molten polymer that may be the same or different than the polymer(s) used to form each of the polymeric components being joined together. In some cases, the molten polymeric charge may be heated to a temperature of about 204° C. (400° F.). In some cases, parts of the two (or more) polymeric components where the charge is to be placed, such as the aforementioned thin ground lines, may be heated to improve chemical bonding. While any of a variety of different polymers may be used in forming each of the polymeric components, in some cases polyethylene or polypropylene may be used. Heating, if done, may involve heating an area of each polymeric component to be joined to a temperature that is about the same as the melting point of polyethylene or polypropylene. The melting point of polyethylene can range from about 110° C. for low density polyethylene to roughly 120° C. to 130° C. for medium and high density polyethylene. The melting point for polypropylene can range from about 130° C. to 171° C.

After the charge has been placed, compressive forces can be applied to the two (or more) polymeric components while the molten polymeric charge cools and solidifies, thereby securing together the two (or more) polymeric components to form the desired polymeric structure. It will be appreciated that the relative amount of the charge may be adjusted depending on tolerances and clearances between the two (or more) polymeric components being joined. In some cases, the two (or more) polymeric components may be made of dissimilar polymers, and a cold molding system may permit these components to be mechanically locked together. In some cases, if the two (or more) polymeric components are made of similar (or identical) polymers, a cold molding system may permit these components to be chemically bonded together. Each of the polymeric components may be molded to have any desired shape or surface textures, such as flat, smooth or grainy, for example.

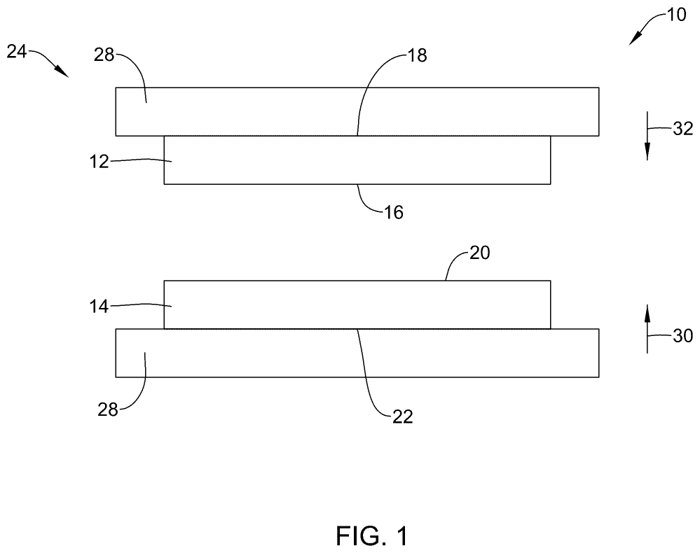

FIG. 1 is a schematic block diagram of a cold molding system 10. In this example, a first polymeric component 12 and a second polymeric component 14 are to be joined together to form a desired polymeric structure. It will be appreciated that the first polymeric component 12 has a first mating surface 16 and a first free surface 18 while the second polymeric component 14 has a second mating surface 20 and a second free surface 22. The first polymeric component 12 and the second polymeric component 14 are positioned such that the first mating surface 16 faces the second mating surface 20.

The first polymeric component 12 and the second polymeric component 14 can be seen as being disposed within a press 24 that includes a first plate 26 and a second plate 28. The press 24 may include appropriate hydraulics (not shown) that are configured to push the first plate 26 towards the second plate 28 in a direction indicated by an arrow 30 and/or push the second plate 28 towards the first plate 26 in a direction indicated by an arrow 32. In some cases, the first polymeric component 12 may be bolted or otherwise secured to the first plate 26. The second polymeric component 14 may be bolted or otherwise secured to the second plate 28. As a result, the first polymeric component 12 and the second polymeric component 14 may be considered as acting as a mold for any additional components that may be disposed between the first polymeric component 12 and the second polymeric component 14.

While the first polymeric component 12 and the second polymeric component 14 are schematically shown as rectilinear, it will be appreciated that this is merely illustrative, as the first polymeric component 12 and the second polymeric component 14 may take any of a variety of different straight or curved shapes. Regardless of the overall shapes of the first polymeric component 12 and the second polymeric component 14, the first mating surface 16 and the second mating surface 20, if not planar, are generally complementary to each other so that they can be joined together. It will be appreciated that while the first plate 26 and the second plate 28 of the press 24 are shown as rectilinear, the first plate 26 and the second plate 28 may take any of a variety of shapes that are complementary to the first free surface 18 and the second free surface 22, respectively, such that the first plate 26 is able to provide a compressive force to the first free surface 18 and the second plate 28 is able to provide a compressive force to the second free surface 22.

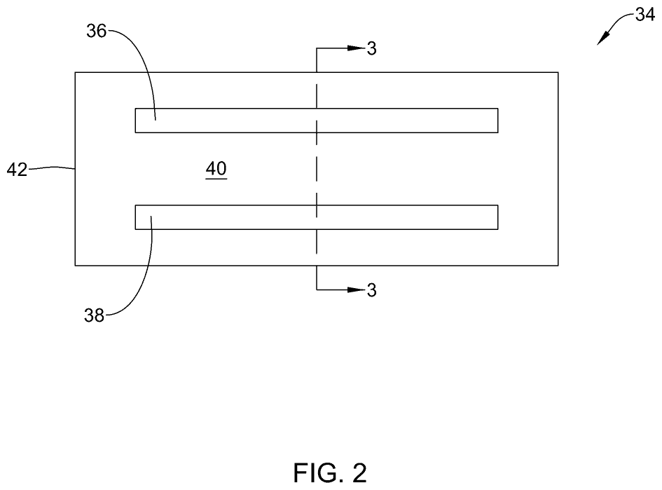

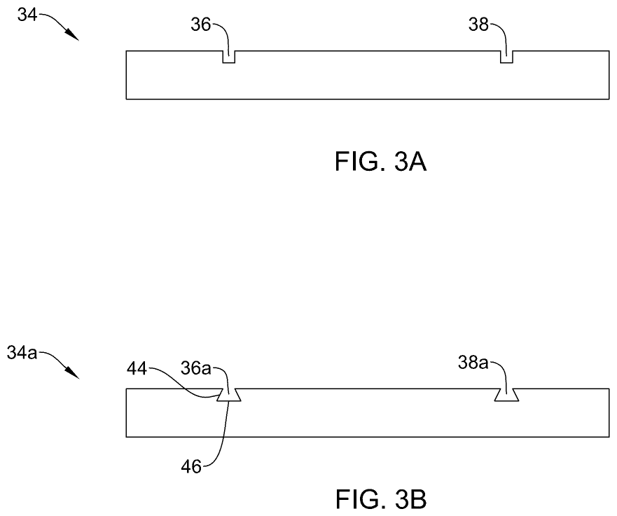

FIG. 2 is a top view of a polymeric component 34 that may be considered as being an example of the first polymeric component 12 or the second polymeric component 14 while FIG. 3 is a cross-sectional view of the polymeric component 34 taken along the line 3-3 of FIG. 2. As shown, the polymeric component 34 may include a first groove 36 and/or a second groove 38. The first groove 36 and the second groove 38 may be parallel to each other, as shown. In some cases, the first groove 36 and the second groove 38 may instead be non-parallel and may intersect each other. The first groove 36 and the second groove 38 may be formed in only one of the first polymeric component 12 and the second polymeric component 14, or the first groove 36 and the second groove 38 may be formed in both the first polymeric component 36 and the second polymeric component 14, for example.

While a pair of grooves 36 and 38 are shown, it will be appreciated that this is merely illustrative. In some cases, the polymeric component 34 may have only a single groove. In some cases, the polymeric component 34 may have three, four or more grooves. The groove(s) may be located within an interior 40 of the polymeric component 34, as shown. In some cases, the groove(s) may be located along a periphery 42 of the polymeric component 34. The groove(s) may correspond to where the polymeric charge is placed when joining the first polymeric component 12 and the second polymeric component 14 together in the cold molding system 10. In some cases, the polymeric component 34 may have be free of grooves (e.g., there may not be any grooves). In such cases, the polymeric charge may be placed at a suitable location along the polymer component 34.

As shown in FIG. 3A, the first groove 36 and the second groove 38 may have a simple rectilinear cross-sectional profile, as may result if the first groove 36 and the second groove 38 were formed using a saw blade, for example. In some cases, the first groove 36 and the second groove 38 may take other forms. In FIG. 3B, a polymeric component 34a may be seen as including a first groove 36a and a second groove 38a that have a cross-sectional profile in which an upper portion 44 of the first groove 36a (or the second groove 38a) has a smaller opening than a bottom 46 of the first groove 36a. It will be appreciated that a molten polymeric charge, when placed into the first groove 36a and the second groove 38a, will be locked into place within the first groove 36a and the second groove 38a when the molten polymeric charge cools and solidifies.

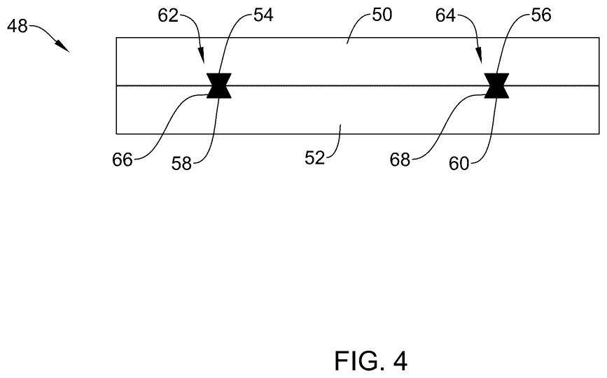

FIG. 4 is a schematic cross-sectional view of a polymeric structure 48 that is formed by joining together a first polymeric component 50 and a second polymeric component 52. The first polymeric component 50 may be considered as being an example of the first polymeric component 12 while the second polymeric component 52 may be considered as being an example of the second polymeric component 14. As shown, the first polymeric component 50 includes a first groove 54 and a second groove 56 that each have a profile similar to the first groove 36a and the second groove 38a. The second polymeric component 52 includes a first groove 58 that aligns with the first groove 54 (of the first polymeric component 50) and a second groove 60 that aligns with the second groove 56 (of the first polymeric component 50). The first groove 58 and the second groove 60 each have a profile similar to the first groove 36a and the second groove 38a.

The first groove 54 and the first groove 58 together form a first locking channel 62. The second groove 56 and the second groove 60 together form a second locking channel 64. The charge disposed within the first locking channel 62 has cooled and solidified into a first polymeric locking member 66. The charge disposed within the second locking channel 64 has cooled and solidified into a second polymeric locking member 68. It will be appreciated that the first polymeric locking member 66 and the second polymeric locking member 68 serve to secure the first polymeric component 50 to the second polymeric component 52 to form the polymeric structure 48.

In some cases, no other securement techniques or methods are needed to secure the first polymeric member 50 to the second polymeric member 52. In some cases, additional techniques such as adhesives may be used. In some cases, additional mechanical securements such as bolts or screws may also be used. These are just examples.

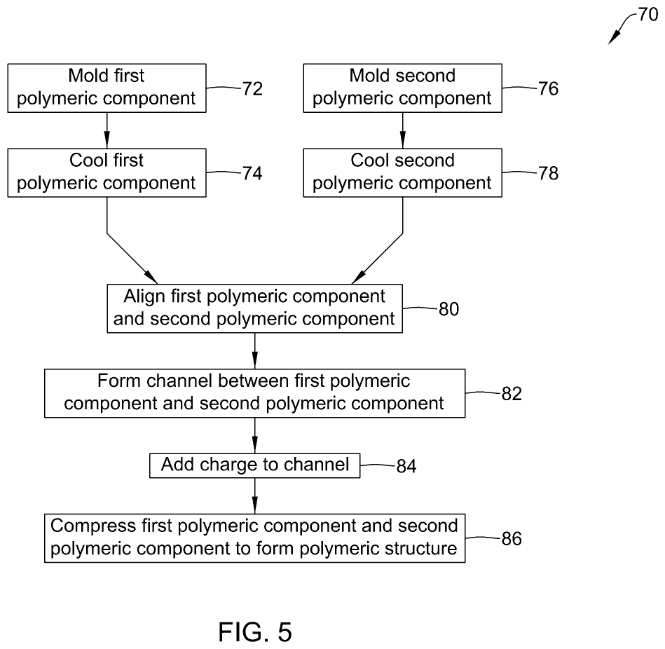

FIG. 5 is a flow diagram showing an illustrative method 70 of forming a polymeric structure from a first polymeric component and a second polymeric component. The first polymeric component may be molded, as indicated at block 72. This may entail molding a single first polymeric component. In some cases, a plurality of first polymeric components may be molded, intended for producing a plurality of polymeric structures. The first polymeric component, or the plurality thereof, are allowed to cool, as indicated at block 74. The second polymeric component may be molded, as indicated at block 76. This may entail molding a single second polymeric component. In some cases, a plurality of second polymeric components may be molded, intended for producing a plurality of polymeric structures. The second polymeric component, or the plurality thereof, are allowed to cool, as indicated at block 78.

A first polymeric component may be aligned with a second polymeric component, as indicated at block 80. This may include aligning the first polymeric component and the second polymeric component such that a mating surface of the first polymeric component aligns with a corresponding mating surface of the second polymeric component. A channel is formed between the first polymeric component and the second polymeric component, as indicated at block 82. This may entail forming a single channel, or a plurality of channels, either in both the first polymeric component and the second polymeric component, or only in one of the first polymeric component and the second polymeric component. A charge is added to the channel(s), as indicated at block 84. The first polymeric component and the second polymeric component are compressed together to form the polymeric structure, as indicated at block 86. In some cases, a compressive force is applied at least until the charge cools and solidifies.

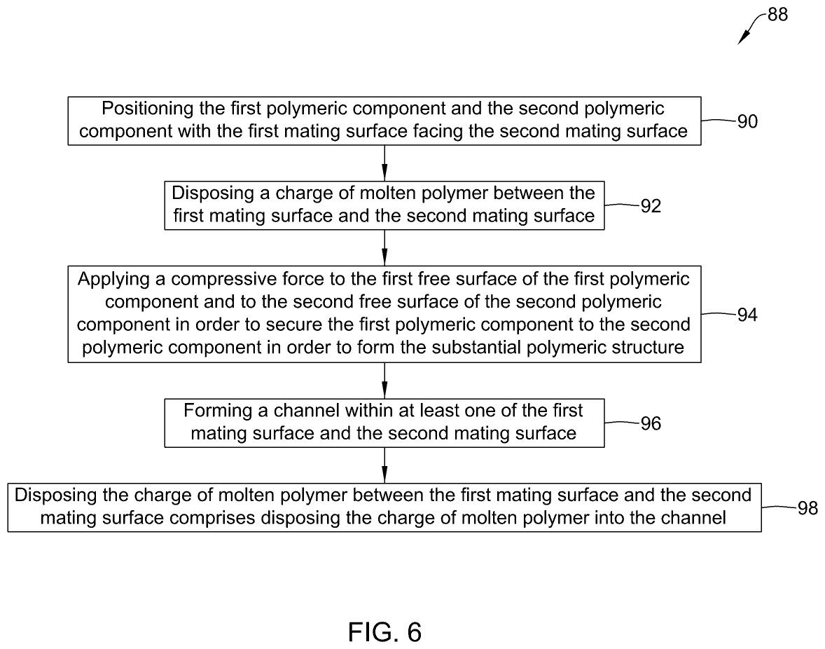

FIG. 6 is a flow diagram showing an illustrative method 88 of forming a polymeric structure including a first polymeric component and a second polymeric component, the first polymeric component including a first mating surface and an opposing first free surface and the second polymeric component including a second mating surface and an opposing second free surface. The first polymeric component and the second polymeric component are positioned with the first mating surface facing the second mating surface, as indicated at block 90. In some cases, the first polymeric component is formed prior to manufacturing the polymeric structure, such as via molding. In some cases, the second polymeric component is formed prior to manufacturing the polymeric structure, such as via molding. The first polymeric component may be at or close to ambient temperature when positioned next to the second polymeric component. The second polymeric component may be at or close to ambient temperature when positioned next to the first polymeric component.

A charge of molten polymer is deposited between the first mating surface and the second mating surface, as indicated at block 92. A compressive force is applied to the first free surface of the first polymeric component and to the second free surface of the second polymeric component in order to secure the first polymeric component to the second polymeric component in order to form the polymeric structure, as indicated at block 94. In some cases, the compressive force to the first free surface of the first polymeric component and to the second free surface of the second polymeric component is maintained until the charge of molten polymer solidifies. In some cases, applying a compressive force to the first free surface of the first polymeric component and to the second free surface of the second polymeric component may include applying a compressive force without applying any heat apart from residual heat from the charge of molten polymer

In some cases, the method 88 further includes forming a channel within at least one of the first mating surface and the second mating surface, as indicated at block 96. In some cases, deposing the charge of molten polymer between the first mating surface and the second mating surface may include disposing the charge of molten polymer into or onto the channel, as indicated at block 98. In some cases, forming a channel includes forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. In some cases, the first channel portion and the second channel portion are configured such that the molten polymer, once solidified, forms a locking member within the first channel portion and the second channel portion that secures the first polymeric component to the second polymeric component.

In some cases, the first mating surface of the first polymeric component includes first component mating features and the second mating surface of the second polymeric component includes second component mating features that are complementary to the first component mating features. The first component mating features may mate with the second component mating features when the first polymeric component and the second polymeric component are positioned with the first mating surface facing the second mating surface. In some cases, the first component mating features include male mating features and the second component mating features include complementary female mating features.

In some cases, the polymeric structure is a construction mat quadrant, where four construction mat quadrants may be assembled together to form a construction mat. The first polymeric component may, for example, be a top half of a construction mat quadrant. The second polymeric component may, for example, be a bottom half of a construction mat quadrant. Joining the top half of the construction mat quadrant to the bottom half of the construction mat quadrant via a cold molding system results in a construction mat. In some cases, the first polymeric component and the second polymeric component are each configured to include additional features that allow the construction mat quadrant to be secured to other construction mat quadrants to form a construction mat.

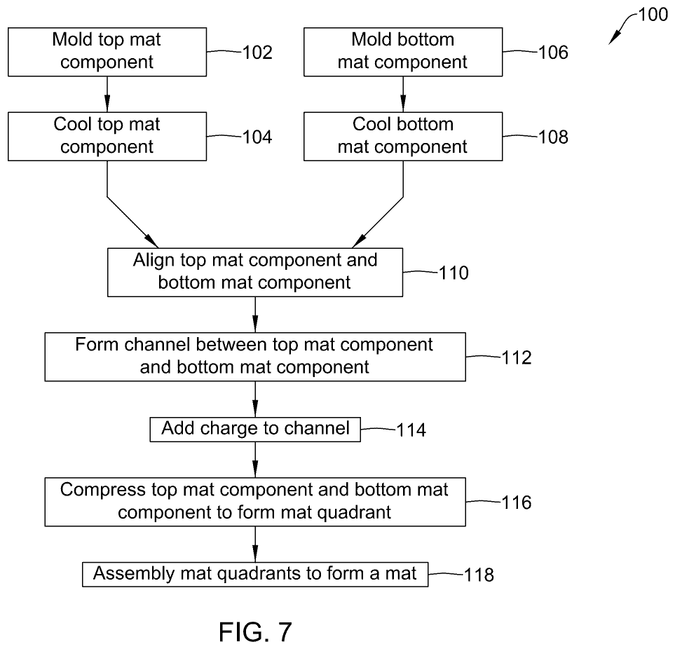

FIG. 7 is a flow diagram showing an illustrative method 100 of forming a construction mat from a top mat component and a bottom mat component. The top mat component may be molded, as indicated at block 102. This may entail molding a single top mat component. In some cases, a plurality of top map components may be molded, intended for producing a plurality of construction mats. The top mat component, or the plurality thereof, are allowed to cool, as indicated at block 104. The bottom mat component may be molded, as indicated at block 106. This may entail molding a single bottom mat component. In some cases, a plurality of bottom mat components may be molded, intended for producing a plurality of construction mats. The bottom mat component, or the plurality thereof, are allowed to cool, as indicated at block 108.

A top mat component may be aligned with a bottom mat component, as indicated at block 110. This may include aligning the top mat component and the bottom mat component such that a mating surface of the top mat component aligns with a corresponding mating surface of the bottom mat component. A channel is formed between the top mat component and the bottom mat component, as indicated at block 112. This may entail forming a single channel, or a plurality of channels, either in both the top mat component and the bottom mat component, or only in one of the top mat component and the bottom mat component. A charge is added to the channel(s), as indicated at block 114. The top mat component and the bottom mat component are compressed together to form the construction mat, as indicated at block 116. In some cases, a compressive force is applied at least until the charge cools and solidifies. Once the construction mat quadrants have been formed via a cold molding process, the construction mat quadrants are joined together in sets of four to form construction mats, as indicated at block 118.

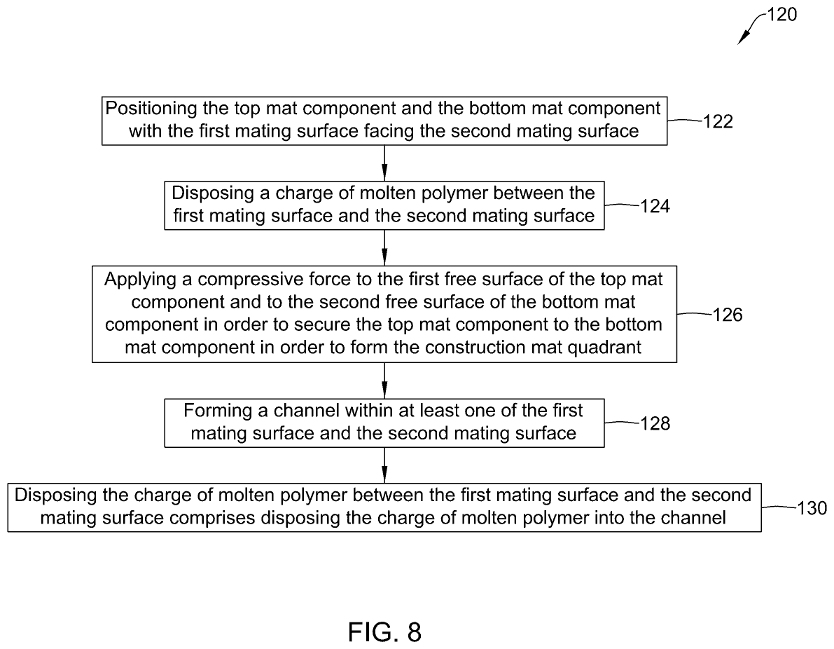

FIG. 8 is a flow diagram showing an illustrative method 120 of manufacturing a construction mat quadrant including a top mat component and a bottom mat component, the top mat component including a first mating surface and a first free surface and the bottom mat component including a second mating surface and a second free surface. The top mat component and the bottom mat component are positioned with the first mating surface facing the second mating surface, as indicated at block 122. The top mat component may be formed, such as via molding, prior to manufacturing the construction mat quadrant. The bottom mat component may be formed, such as via molding, prior to manufacturing the construction mat quadrant. The top mat component may be at or close to ambient temperature when positioned relative to the bottom mat component. The bottom mat component may be at or close to ambient temperature when positioned relative to the top mat component.

A charge of molten polymer is disposed between the first mating surface and the second mating surface, as indicated at block 124. A compressive force is applied to the first free surface of the top mat component and to the second free surface of the bottom mat component in order to secure the top mat component to the bottom mat component in order to form the construction mat quadrant, as indicated at block 126. The compressive force to the first free surface of the top mat component and to the second free surface of the bottom mat component may be maintained until the charge of molten polymer solidifies. In some cases, applying a compressive force to the first free surface of the top mat component and to the second free surface of the bottom mat component may include applying a compressive force without applying any heat apart from residual heat from the charge of molten polymer.

In some cases, the method 120 may also include forming a channel within at least one of the first mating surface and the second mating surface, as indicated at block 128. In some cases, disposing the charge of molten polymer between the first mating surface and the second mating surface may include disposing the charge of molten polymer into the channel, as indicated at block 130. In some cases, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. In some cases, the first channel portion and the second channel portion are configured such that the molten polymer, once solidified, forms a locking member within the first channel portion and the second channel portion that secures the top mat component to the bottom mat component.

In some cases, the first mating surface includes first component mating features and the second mating surface includes second component mating features that are complementary to the first component mating features. In some cases, the first component mating features mate with the second component mating features when the top mat component and the bottom mat component are positioned with the first mating surface facing the second mating surface. As an example, the first component mating features may include male mating features and the second component mating features may include complementary female mating features.

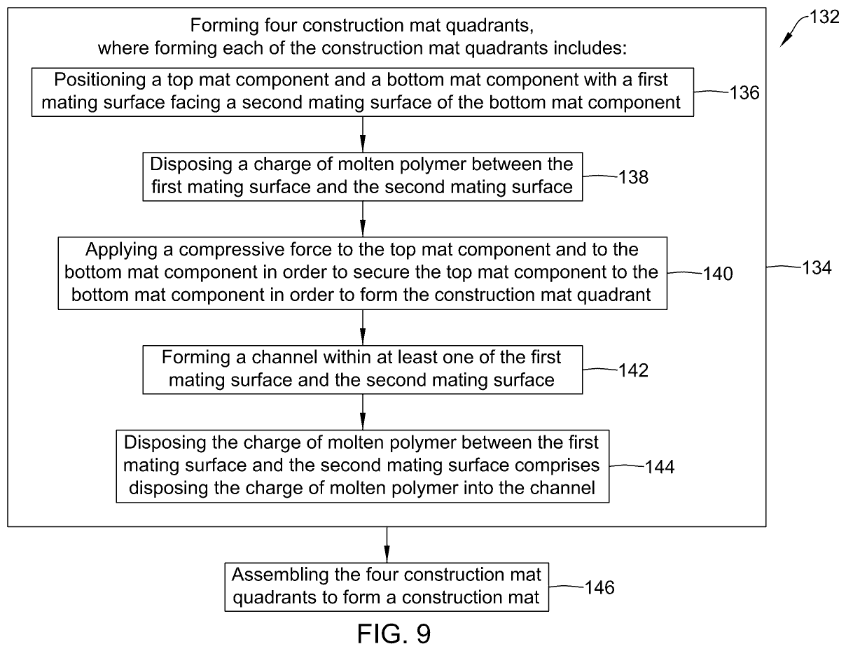

FIG. 9 is a flow diagram showing an illustrative method 132 of manufacturing a construction mat. Four construction mat quadrants are formed, as indicated at block 134. Forming each of the construction mat quadrants includes positioning a top mat component and a bottom mat component with a first mating surface of the top mat component facing a second matting surface of the bottom mat component, as indicated at block 136. A charge of molten polymer is disposed between the first mating surface and the second mating surface, as indicated at block 138. A compressive force is applied to the top mat component and to the bottom mat component in order to secure the top mat component to the bottom mat component in order to form the construction mat quadrant, as indicated at block 140. In some cases, the compressive force to the each top mat component and to each bottom mat component may be maintained until the corresponding charge of molten polymer solidifies. In some cases, applying a compressive force to each top mat component and to each bottom mat component may include applying a compressive force without applying any heat apart from residual heat from the corresponding charge of molten polymer.

In some cases, the method 132 includes forming a channel within at least one of the first mating surface and the second mating surface, as indicated at block 142. In some cases, disposing the charge of molten polymer between the first mating surface and the second mating surface may include disposing the charge of molten polymer into the channel, as indicated at block 144. The four construction mat quadrants may then be assembled to form a construction mat, as indicated at block 146.

In some cases, forming a channel may include forming a first channel portion in the first mating surface and a corresponding second channel portion in the second mating surface and disposing the charge of molten polymer between the first mating surface and the second mating surface may include disposing the charge of molten polymer into the first channel portion and into the second channel portion. The first channel portion and the second channel portion may be configured such that the molten polymer, once solidified, forms a locking member within the first channel portion and the second channel portion that secures the top mat component to the bottom mat component.

In some cases, the top mat component for each construction mat quadrant may be formed prior to manufacturing the construction mat. At least some of the top mat components may be formed via molding. In some cases, the bottom mat component for each construction mat quadrant may be formed prior to manufacturing the construction mat. At least some of the bottom mat components may be formed via molding. In some cases, each top mat component may be at or close to ambient temperature when positioned relative to the corresponding bottom mat component. In some cases, each bottom mat component may be at or close to ambient temperature when positioned relative to the corresponding top mat component.

In some cases, the first mating surface includes first component mating features and the second mating surface includes second component mating features that are complementary to the first component mating features. The first component mating features may mate with the second component mating features when the top mat component and the bottom mat component are positioned with the first mating surface facing the second mating surface. In some cases, the first component mating features may include male mating features and the second component mating features may include complementary female mating features.

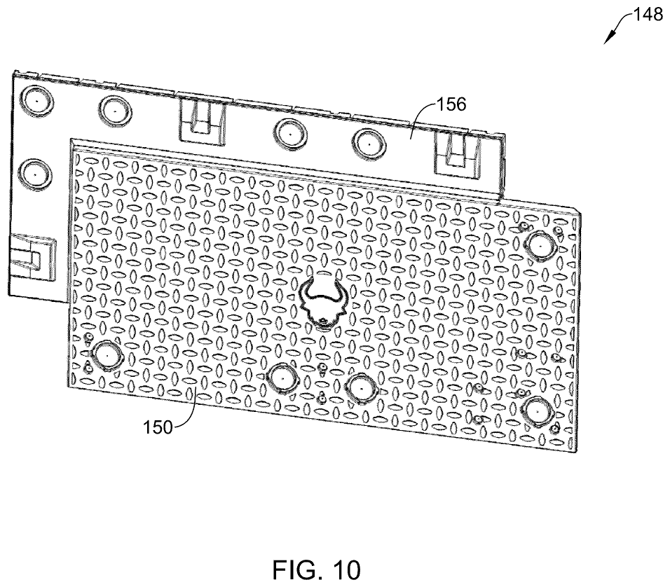

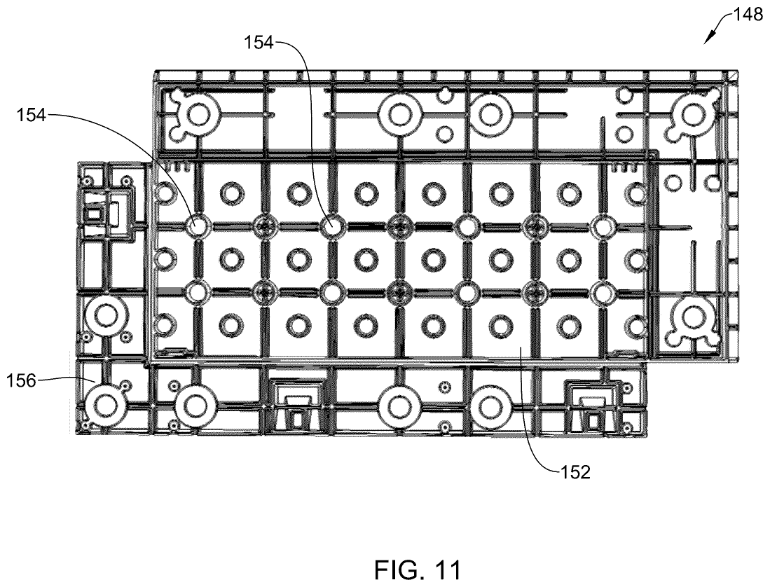

FIG. 10 is a perspective view of an upper portion of a top mat component 148 and FIG. 11 is a perspective view of a corresponding lower portion of the top mat component 148. The top mat component 148 includes an upper working surface 150 that will ultimately form the upper work surface of the construction mat that will be formed using the top mat component 148. The upper work surface corresponds to the surface that will be driven on, for example. The top mat component 148 includes a lower surface 152 that will abut a corresponding bottom mat component. It will be appreciated that the upper working surface 150 corresponds to the first free surface 18 of the first polymeric component 12 and the lower surface 152 corresponds to the first mating surface 16 of the first polymeric component 12 as shown in FIG. 1.

The lower surface 152 of the top mat component 148 includes a number of mating features 154 that will align with complementary mating features on the bottom mat component. In some cases, the mating features 154 may be considered to be male mating features, but this is not required in all cases. The top mat component 148 also includes a flange 156 by which construction mat quadrants are joined together to form a construction mat.

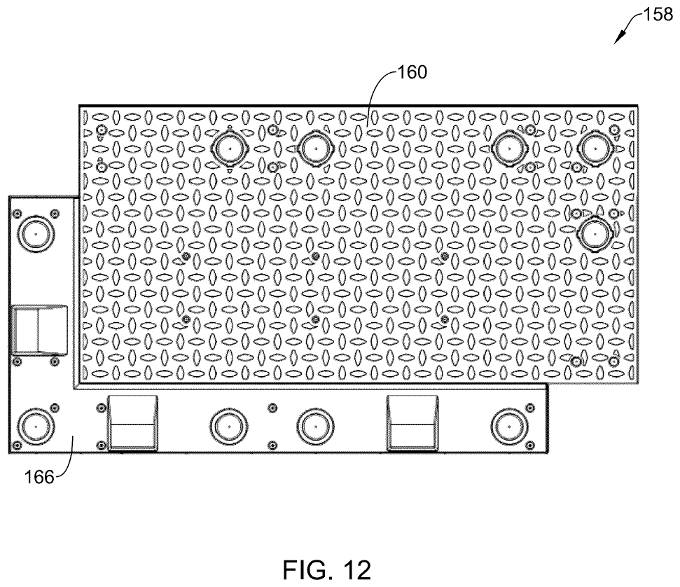

FIG. 12 is a perspective view of an upper portion of a bottom mat component 158 and FIG. 12 is a perspective view of a corresponding lower portion of the bottom mat component 158. The bottom mat component 158 includes a working surface 160 that will ultimately form the lower work surface of the construction mat that will be formed using the bottom mat component 158. The lower work surface corresponds to the surface that will abut whatever material the construction mat is placed on. The bottom mat component 158 includes an upper surface 162 that will abut the corresponding lower surface 152 of the top mat component 148. It will be appreciated that the working surface 160 corresponds to the second free surface 22 of the second polymeric component 14 and the upper surface 162 corresponds to the second mating surface 18 of the second polymeric component 14 as shown in FIG. 1.

The upper surface 162 of the bottom mat component 158 includes a number of mating features 164 that will align with the mating features 154 on the top mat component 148. In some cases, the mating features 164 may be considered to be female mating features, but this is not required in all cases. In some cases, a male mating feature such as one of the mating features 154 fit into a corresponding female mating feature such as one of the mating features 164. The bottom mat component 158 also includes a flange 166 that aligns with the flange 156.

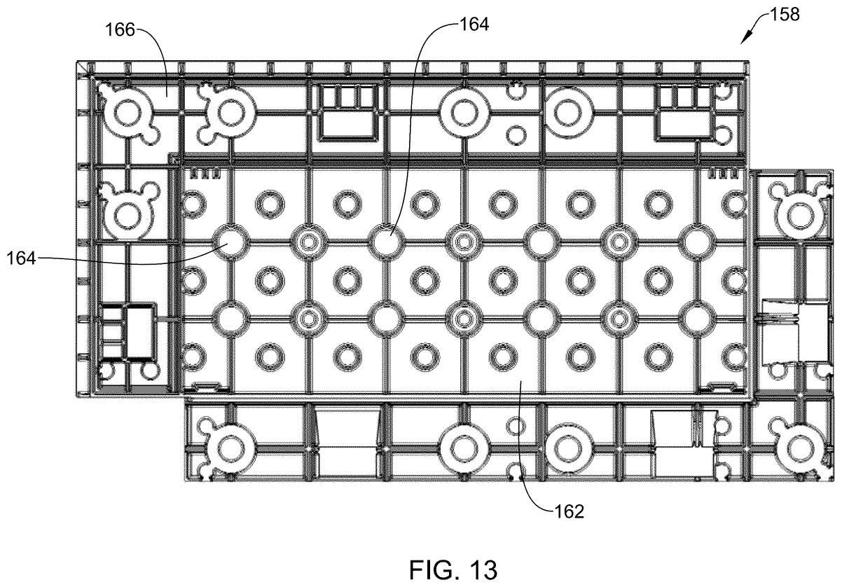

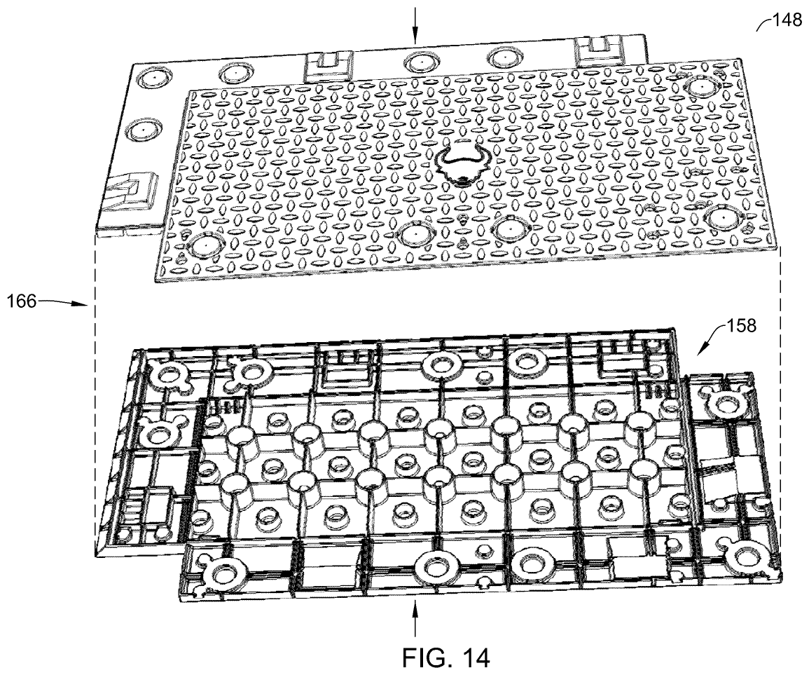

FIG. 14 is a perspective view showing the top mat component 148 shown in FIGS. 10 and 11 being aligned with and joined with the bottom mat component 158 shown in FIGS. 12 and 13. It will be appreciated that by placing the top mat component 148 and the bottom mat component 158 into the cold molding system 10 shown in FIG. 1 in the illustrated relative orientations, that the top mat component 148 may be joined to the bottom mat component 158 to form a construction mat quadrant 168.

With reference to the polymeric component 12 and the polymeric component 14 shown in FIG. 1, it will be appreciated that in some instances, the polymeric component 12 may represent a molded or even molded top mat component while the polymeric component 14 may represent a molded or even molded bottom mat component. While FIG. 1 shows the polymeric component 12 and the polymeric component 14 being joined via a cold molding process, this is merely illustrative, as any of a variety of processes, including other molding processes, adhesives or even fasteners may be used in joining the polymeric component 12 and the polymeric component 14.

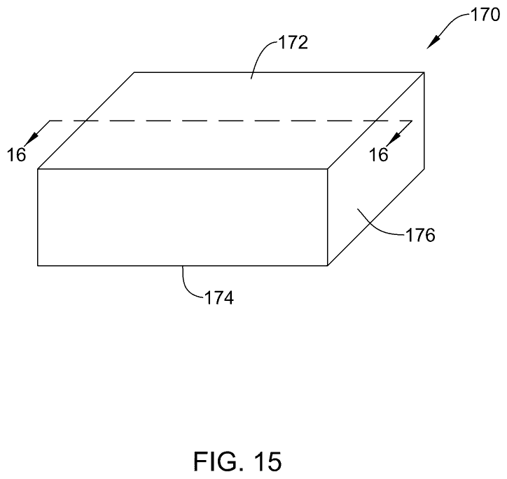

FIG. 15 is a schematic perspective view of an illustrative molded mat component 170 that may be considered as representing either of a molded top mat component or a molded bottom mat component. In some instances, the molded mat component 170 may be molded, but this is not required. While the molded mat component 170 is shown as having a rectilinear profile, it will be appreciated that this is merely illustrative, and the molded mat component 170 may have any of a variety of different profiles. The molded mat component 170 includes an upper (in the illustrated orientation) surface 172, a lower surface 174 and a periphery 176 that extends around the molded mat component 170 between the upper surface 172 and the lower surface 174.

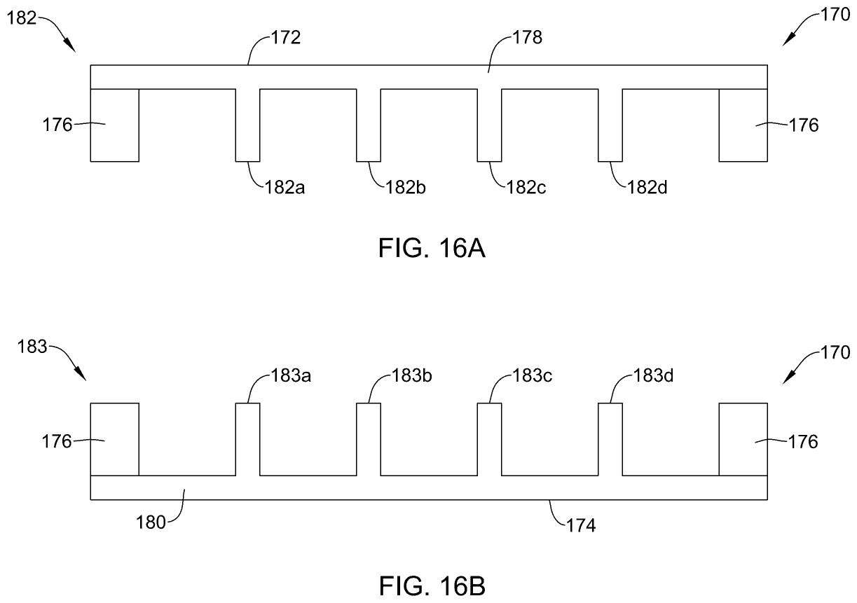

FIG. 16A is a first schematic cross-sectional view of the molded mat component 170, taken along the line 16-16 of FIG. 15, and FIG. 16B is a second schematic cross-sectional view thereof. As can be seen in FIG. 16A, the molded mat component 170 may include an upper segment 178 that defines the upper surface 172. A wall segment extends around the molded mat component between the upper segment 178 and defines the sides or periphery 176 of the molded mat component 170. As seen, the molded mat component 170 may include a number of ribs 182, individually labeled as 182a, 182b, 182c and 182d. In some instances, the ribs 182 may extend downward (in the illustrated orientation) from the upper segment 178. In some instances, the ribs 182 may have a length equal to that of the wall forming the periphery 176. In some instances, the ribs 182 may be shorter than that of the wall forming the periphery 176. While a total of four ribs 182 are shown, this is merely illustrative, as depending on the dimensions of the molded mat component 170, the molded mat component 170 may include considerably more ribs 182. As will be discussed, in some instances at least some of the ribs 182 may include reinforcing members. The ribs 182 may be arranged in a variety of layouts. A total number of ribs 182 may vary, depending on the dimensions of the molded mat component 170.

FIG. 16B shows that the molded mat component 170 may include a lower segment 180 and the periphery 176. As seen, the molded mat component 170 may include a number of ribs 183, individually labeled as 183a, 183b, 183c and 183d. In some instances, the ribs 183 may extend upward (in the illustrated orientation) from the lower segment 180. In some instances, the ribs 183 may have a length equal to that of the wall forming the periphery 176. In some instances, the ribs 183 may be shorter than that of the wall forming the periphery 176. While a total of four ribs 183 are shown, this is merely illustrative, as depending on the dimensions of the molded mat component 170, the molded mat component 170 may include considerably more ribs 183. As will be discussed, in some instances at least some of the ribs 183 may include reinforcing members. The ribs 183 may be arranged in a variety of layouts. A total number of ribs 183 may vary, depending on the dimensions of the molded mat component 170.

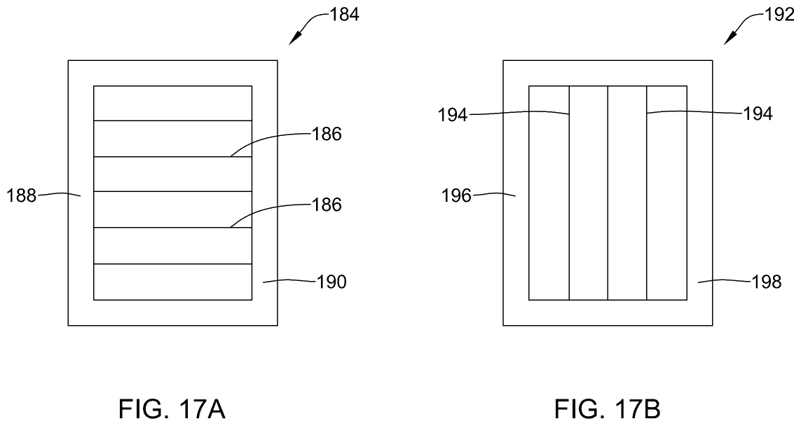

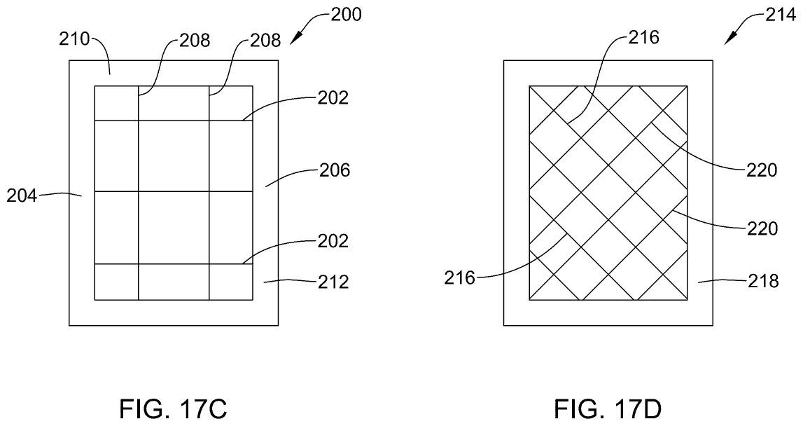

FIG. 17A schematically shows a molded mat segment 184 that is shown without an upper segment in order to show how ribs 186 can be arranged. It will be appreciated that the ribs 186 are shown schematically, and are three-dimensional. In FIG. 17A, the ribs 186 are arranged in parallel fashion, and extend from a first periphery side 188 to a second periphery side 190. FIG. 17B schematically shows a molded mat segment 192 that is shown without an upper segment in order to show how ribs 194 are arranged. It will be appreciated that the ribs 194 are shown schematically, and are three-dimensional. The ribs 194 are arranged in parallel fashion, and extend from an upper (in the illustrated orientation) periphery side 196 to a second periphery side 198.

FIG. 17C schematically shows a molded mat segment 200 that is shown without an upper segment in order to show how the ribs are arranged. It will be appreciated that the ribs are shown schematically, and are three-dimensional. The molded mat segment 200 includes a first set of ribs 202 that extend in parallel fashion from a first periphery side 204 to a second periphery side 206. The molded mat segment 200 includes a second set of ribs 208 that extend in parallel fashion from an upper (in the illustrated orientation) periphery side 210 to a lower periphery side 212. In some instances, each of the first set of ribs 202 may be arranged orthogonally relative to the second set of ribs 208. In some instances, each of the first set of ribs 202 and the second set of ribs 208 may form an acute angle therebetween.

FIG. 17D schematically shows a molded mat segment 214 that is shown without an upper segment in order to show how the ribs are arranged. It will be appreciated that the ribs are shown schematically, and are three-dimensional. The molded mat segment 214 includes a first set of ribs 216 that extend in parallel fashion from an upper left (in the illustrated orientation) portion of a periphery 218 to a lower right portion of the periphery 218. The molded mat segment 214 includes a second set of ribs 220 that extend in parallel fashion from a lower left portion of the periphery 218 to an upper right portion of the periphery 218. In some instances, the first set of ribs 216 are orthogonal to the second set of ribs 220. In some instances, each of the first set of ribs 216 and the second set of ribs 220 may form an acute angle therebetween.

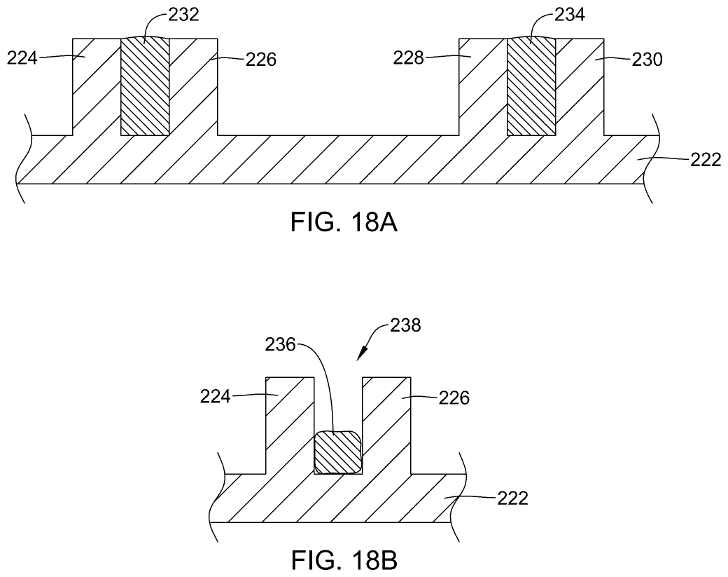

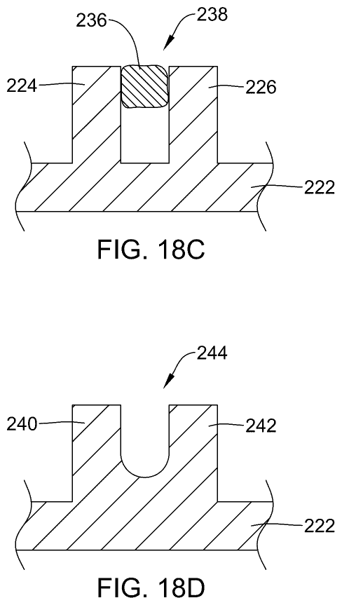

In some instances, reinforcing members may be added to or otherwise incorporated into the ribs within either a molded top construction mat component or a molded bottom construction mat component. FIGS. 18A through 18C are schematic views of several ribs that include reinforcing members. In FIG. 18A, a molded structure 222 (only a portion of which is shown), which may be considered as representing a portion of the upper segment 178 shown in FIG. 16A and/or a portion of the lower segment 180 shown in FIG. 16B, includes several ribs that are arranged in pairs. A first pair of ribs includes a first rib 224 and a second rib 226. The second rib 226 may be spaced any desired distance from the first rib 224. As an example, the second rib 226 may be spaced less than one inch from the first rib 224. The second rib 226 may be spaced less than one half inch from the first rib 224. The second rib 226 may be spaced less than one quarter inch from the first rib 224. In some instances, the spacing between the first rib 224 and the second rib 226 may be selected to accommodate a particular reinforcing member placed between the first rib 224 and the second rib 226. In some instances, the first rib 224 and the second rib 226 are at least 0.125 inches apart.

A second pair of ribs includes a first rib 228 and a second rib 230. The second rib 230 may be spaced any desired distance from the first rib 228. As an example, the second rib 230 may be spaced less than one inch from the first rib 228. The second rib 230 may be spaced less than one half inch from the first rib 228. The second rib 230 may be spaced less than one quarter inch from the first rib 228. In some instances, the spacing between the first rib 228 and the second rib 230 may be selected to accommodate a particular reinforcing member placed between the first rib 228 and the second rib 230. In some instances, the first rib 228 and the second rib 230 are at least 0.125 inches apart. The relative spacing between pairs of ribs, such as the spacing between the second rib 226 and the first rib 228, may vary depending on the weight bearing requirements of the resulting construction mat. In some instances, the pairs of ribs may be spaced at least two or more inches apart.

A first reinforcing member 232 is disposed between the first rib 224 and the second rib 226. In some instances, the first reinforcing member 232 is sized to fit easily between the first rib 224 and the rib 226. In some instances, a thermal process may be used by which the first rib 224 and the second rib 226 are heated to at least 160° F. before inserting the first reinforcing member 232 between the first rib 224 and the second rib 226. As the first rib 224 and the second rib 226 (and presumably the first reinforcing member 232) cools, the first reinforcing member 232 is secured between the first rib 224 and the second rib 226 as the first rib 224 and the second rib 226 cool.

A second reinforcing member 234 is disposed between the first rib 228 and the second rib 230. In some instances, the second reinforcing member 234 is sized to fit easily between the first rib 228 and the second rib 230. In some instances, a thermal process may be used by which the first rib 228 and the second rib 230 are heated to at least 160° F. before inserting the second reinforcing member 234 between the first rib 228 and the second rib 230. As the first rib 228 and the second rib 230 (and presumably the second reinforcing member 234) cools, the second reinforcing member 234 is secured between the first rib 228 and the second rib 230 as the first rib 228 and the second rib 230 cool.

In some instances, the first reinforcing member 232 and/or the second reinforcing member 234 may be formed of a metallic material such as steel. In some instances, the first reinforcing member 232 and/or the second reinforcing member 234 may be formed of a fibrous material such as wood. In some instances, the first reinforcing member 232 and/or the second reinforcing member 234 may be formed of a polymeric material. In some instances, the first reinforcing member 232 and/or the second reinforcing member 234 may be formed of a mixture or combination of fibrous material and polymeric material.

As shown, the first reinforcing member 232 and the second reinforcing member 234 extend the full height or essentially the full height of each of the first rib 224 and the second rib 226 and the first rib 228 and the second rib 230, respectively. In some instances, the reinforcing members may not be the same height as the ribs the reinforcing members are disposed within. As an example, FIG. 18B shows a reinforcing member 236 that is smaller in height than either the first rib 224 or the second rib 226, and is disposed at a bottom of a void 238 that is formed between the first rib 224 and the second rib 226. As another example, FIG. 18C shows the reinforcing member 236 disposed at or near an upper portion of the void 238 that is formed between the first rib 224 and the second rib 226.

In some instances, the first reinforcing member 232 may extend a length of the molded structure 222, and may for example extend a length of the first rib 224 and the second rib 226. In some instances, the first reinforcing member 232 may include two, three or more distinct reinforcing members aligned end to end between the first rib 224 and the second rib 226. In some instances, the first reinforcing member 232 may be shorter than the length of the molded structure 222. In some instances, the second reinforcing member 234 may extend a length of the molded structure 222, and may for example extend a length of the first rib 228 and the second rib 230. In some instances, the second reinforcing member 234 may include two, three or more distinct reinforcing members aligned end to end between the first rib 228 and the second rib 230. In some instances, the second reinforcing member 234 may be shorter than the length of the molded structure 222.

In some instances, as shown for example in FIGS. 18B and 18C, the void 238 may have a depth that is equal to a height of the first rib 224 and the second rib 226 defining the void 238 therebetween. In some instances, the void 238 may have a depth that is less than the height of the first rib 224 and the second rib 226 defining the void 238 therebetween. FIG. 18D schematically shows a portion of the molded structure 222, including a first rib 240, a second rib 242 and a void 244 disposed between the first rib 240 and the second rib 242. As can be seen, the void 244 has a depth that is less than a height of either the first rib 240 or the second rib 242.

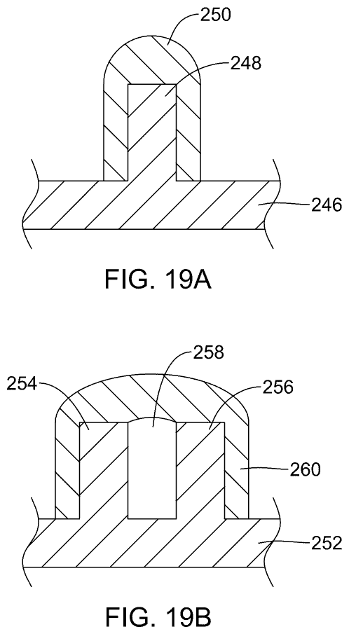

In some instances, a reinforcing member may fit over one or more ribs, rather than fitting between adjacent ribs. FIG. 19A shows a portion of a molded structure 246 that includes a rib 248. A U-shaped reinforcing member 250 may be seen as extending in an inverted orientation over the rib 248. In some instances, a thermal process may be used in securing the U-shaped reinforcing member 250 in position relative to the rib 248. While a single rib 248 and a single U-shaped reinforcing member 250 are shown, it will be appreciated that a construction mat component may include a plurality of ribs and a corresponding plurality of U-shaped reinforcing members. In some instances, the U-shaped reinforcing member 250 may be formed of steel.

FIG. 19B shows a portion of a molded structure 252 that includes a first rib 254 and a second rib 256, defining a void space 258 between the first rib 254 and the second rib 256. A U-shaped reinforcing member 260 may be seen as extending in an inverted orientation over the first rib 254, the second rib 256 and the intervening void space 258. In some instances, a thermal process may be used in securing the U-shaped reinforcing member 260 in position relative to the first rib 254 and the second rib 256. Other processes and/or structures may be used to secure the U-shaped reinforcing member 260 relative to the first rib 254 and the second rib 256 such as adhesive bonding, mechanical bonding, bonding with a fastener (e.g., such as a screw, bolt, etc.), incorporating a projection or not into the ribs 254, 256 that interacts with the U-shaped reinforcing member 260, combinations thereof, and/or the like. While a single pair of ribs 254 and 256 and a single U-shaped reinforcing member 260 are shown, it will be appreciated that a construction mat component may include a plurality of ribs and a corresponding plurality of U-shaped reinforcing members. In some instances, the U-shaped reinforcing member 260 may be formed of steel.

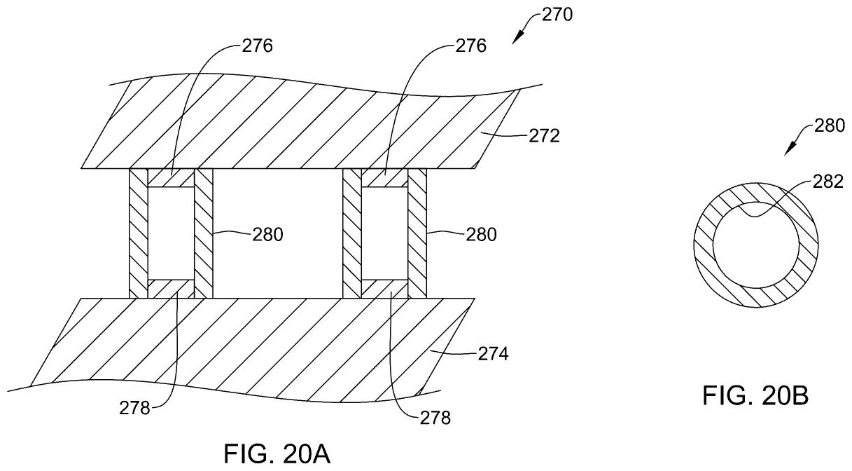

FIG. 20A is a schematic view of an assembly 270 that includes a top mat component 272 and a bottom mat component 274 that may be assembled together to form a construction mat. The top mat component 272 includes several protuberances 276 that extend in a downward (in the illustrated orientation) direction, or towards the bottom mat component 274, and the bottom mat component 274 includes several protuberances 278 that extend in an upward direction, or towards the upper mat component 274. In some instances, the protuberances 276 may be considered as being similar to the mating features 154 shown for example in FIG. 11 and the protuberances 278 may be considered as being similar to the mating features 164 shown for example in FIG. 13. While the mating features 154 and 164 may be configured to fit into each other, the protuberances 276 and 278 may be the same size, and may be configured to accommodate a tubular reinforcing member 280.

The tubular reinforcing members 280 may have any cross-sectional shape, as long as the cross-sectional shape is complementary to that of the protuberances 276 and 278. The tubular reinforcing members 280 may have a square cross-sectional shape, or a triangular cross-sectional shape, for example. In some instances, the tubular reinforcing members 280 may be cylindrical, having a circular cross-sectional shape. FIG. 20B is a perspective view of the tubular reinforcing member 280. The tubular reinforcing member 280 has an inner surface 282 that is dimensioned to accommodate the protuberances 276 and 278. The inner surface 282 may be dimensioned to allow the tubular reinforcing members 280 to be easily slipped into position on the protuberances 276 and 278. In some instances, the inner surface 282 may be dimensioned such that force is required to get the protuberances 276 and 278 to fit into the tubular reinforcing member 280.

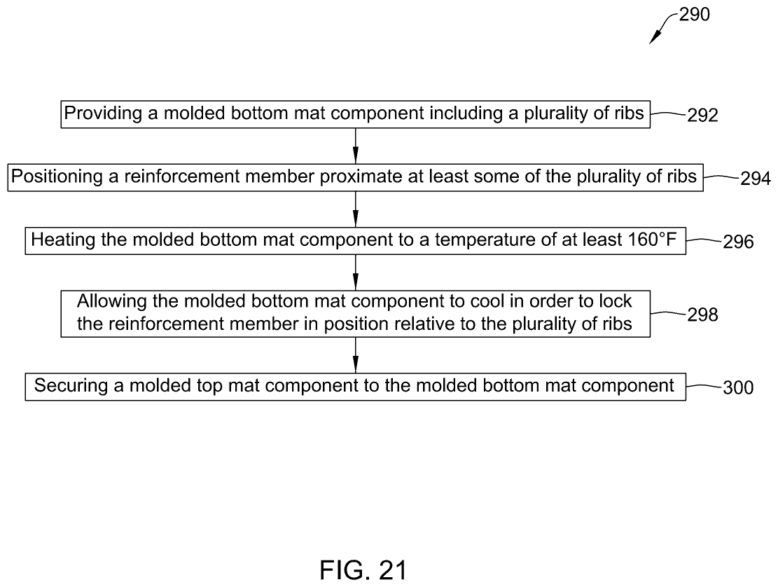

FIG. 21 is a flow diagram showing an illustrative method 290 of forming a construction mat section. The method 290 includes providing a molded bottom mat component including a plurality of ribs, as indicated at block 292. A reinforcement member is positioned proximate at least some of the plurality of ribs, as indicated at block 294. The molded bottom mat component is heated to a temperature of at least 160° F., as indicated at block 296. The molded bottom mat component is allowed to cool in order to lock the reinforcement member in position relative to the plurality of ribs, as indicated at block 298. A molded top mat component is secured to the molded bottom mat component, as indicated at block 300. In some instances, securing the molded top mat component to the molded bottom mat component may include using a cold molding process. In some instances, securing the molded top mat component to the molded bottom mat component may include using fasteners.

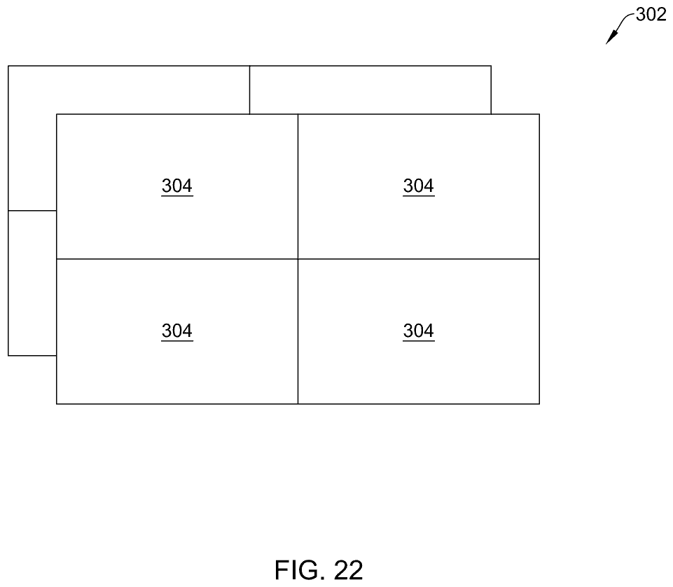

FIG. 22 is a schematic top view of an illustrative construction mat assembly 302. The construction mat assembly 302 may be formed by assembling together a total of four construction mat quadrants or sections 304 that were each formed from a top mat component and a bottom mat component. In some instances, the top mat component and the bottom mat component may be joined together to form one of the construction mat quadrants 166 a molding processing such as the cold molding process described herein, or using any of a variety of other processes as well. The construction mat quadrants or sections 304 may be secured together via the flanges 156/166 using any suitable fastening techniques and methods.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A construction mat section, comprising:
a molded bottom mat component;
a molded top mat component configured to be securable to the molded bottom mat component;
a plurality of ribs formed in at least one of the molded top mat component and the molded bottom mat component; and
one or more reinforcing members secured relative to at least some of the plurality of ribs.

2. The construction mat section of claim 1, wherein the plurality of ribs are arranged in pairs of ribs, with each pair of ribs including a first rib and a second rib that is spaced less than one inch apart from the first rib, and at least some of the pairs of ribs include one of the one or more reinforcing members disposed between the first rib and the second rib.

3. The construction mat section of claim 2, wherein the reinforcing member is secured between the first rib and the second rib using a thermal process in which the first rib and the second rib are heated to at least 160° F.

4. The construction mat section of claim 2, wherein for at least some of the pairs of ribs, the first rib and the second rib are spaced less than one half inch apart.

5. The construction mat section of claim 2, wherein for at least some of the pairs of ribs, the first rib and the second rib are spaced less than one quarter inch apart.

6. The construction mat section of claim 1, wherein at least some of the one or more reinforcing members have a U-shaped profile and fit over one or more of the ribs.

7. The construction mat section of claim 1, wherein the one or more reinforcing members comprise a metal, a fibrous material, a polymeric material or combinations thereof.

8. The construction mat section of claim 2, wherein at least some of the one or more reinforcing members extend a length of at least some of the pairs of ribs spaced less than one inch apart.

9. A construction mat assembly comprising four of the construction mat sections of claim 1, joined together.

10. A construction mat section, comprising:
a molded top mat component including a first mating surface;
a molded bottom mat component including a second mating surface in opposition with the first mating surface; and
a plurality of tubular reinforcing members extending between the first mating surface and the second mating surface.

11. The construction mat section of claim 10, wherein the first mating surface comprises protuberances configured to accommodate each of the plurality of tubular reinforcing members.

12. The construction mat section of claim 10, wherein the second mating surface comprises protuberances configured to accommodate each of the plurality of tubular reinforcing members.

13. The construction mat section of claim 10, wherein at least some of the plurality of tubular reinforcing members comprise cylindrical reinforcing members.

14. The construction mat section of claim 10, wherein at least some of the tubular reinforcing members comprise steel reinforcing members.

15. The construction mat section of claim 10, wherein the tubular reinforcing members are secured between the molded top mat component and the molded bottom mat component at a temperature of at least 160° F.

16. The construction mat section of claim 10, wherein the molded bottom mat component and the molded top mat component have a combined thickness of less than three inches.

17. The construction mat section of claim 10, wherein at least one of the molded top mat component and the molded bottom mat component further comprises a plurality of ribs in combination with the plurality of tubular reinforcing members.

18. A method of forming a construction mat section, the method comprising:
providing a molded bottom mat component including a plurality of ribs;
positioning a reinforcement member proximate at least some of the plurality of ribs;
heating the molded bottom mat component to a temperature of at least 160° F.;
allowing the molded bottom mat component to cool in order to lock the reinforcement member in position relative to the plurality of ribs; and
securing a molded top mat component to the molded bottom mat component.

19. The method of claim 17, wherein securing the molded top mat component to the molded bottom mat component comprises using a cold molding process.

20. The method of claim 17, wherein securing the molded top mat component to the molded bottom mat component comprises using fasteners.
